(19) United States
(12) Patent Application Publication
(10) Pub. No.: US 2025/0253750 A1
(43) Pub. Date: Aug. 7, 2025

(54) LINEAR DRIVE SYSTEM, ROTOR ASSEMBLY AND STATOR ASSEMBLY

(71) Applicant: Beckhoff Automation GmbH, Verl (DE)

(72) Inventors: Manuel Schröder, Würzburg (DE); Christian Ott, Lauda-Königshofen (DE); Andreas Golf, Oerlinghausen (DE)

(21) Appl. No.: 19/179,114

(22) Filed: Apr. 15, 2025

Related U.S. Application Data
(63) Continuation of application No. PCT/EP2023/083586, filed on Nov. 29, 2023.

(30) Foreign Application Priority Data
Dec. 1, 2022 (DE) 10 2022 131 900.8

(51) Int. Cl. H02K 41/02; H02K 11/00; H02K 11/21

(52) U.S. Cl. CPC H02K 41/02; H02K 11/0094; H02K 11/21; H02K 2213/09

(57) ABSTRACT

A linear drive system includes a stator assembly with at least one guide rail on which a rotor assembly can travel. The stator assembly includes a stator magnet assembly for providing a stator magnetic field. The rotor assembly includes a rotor magnet assembly for providing a rotor magnetic field, and can be moved along the guide rail via a magnetic coupling between the stator and rotor fields. An encoder system with an encoder unit is arranged on the rotor assembly, and a dimensional scale is arranged on the stator assembly. The encoder unit is fixed to the rotor assembly via a locking device, and displaceable along at least one predefined direction. The distance between the encoder unit and the dimensional scale varies via displacement of the encoder unit, when the rotor assembly is positioned on the guide rail. A rotor, stator assembly and planar drive system are also described.

### CROSS-REFERENCE TO RELATED APPLICATIONS

The present patent application is a continuation of International Patent Application No. PCT/EP2023/083586, filed Nov. 29, 2023, “Linear Drive System, Rotor Unit, and Stator Unit,” which claims the priority of German patent application DE 10 2022 131 900.8, filed Dec. 1, 2022, “Lineares Antriebssystem, Laufereinheit und Statoreinheit,” the disclosure content of each of which is hereby incorporated by reference herein, in the entirety and for all purposes.

### FIELD

This application relates to a linear drive system as well as to a rotor assembly and to a stator assembly for a linear drive system.

### BACKGROUND

Linear drive systems, generally also referred to as linear motors, may be used in automation technology, particularly in production technology, handling technology and process engineering. Linear drive systems allow for precise and fast transportation of goods along predefined transport paths. Magnetically energized linear drive systems are known from the state of the art. Magnetically energized linear drive systems use magnetic coupling of stator magnetic fields of a stator assembly and rotor magnetic fields of rotor assemblies of the linear drive system.

By controlling the rotor magnetic fields and/or stator magnetic fields, the rotor assemblies may be moved along the predefined transport paths. The advantages of the magnetically energized drive are the high precision of the control of the individual rotor assemblies. Furthermore, the magnetically energized drive is a direct drive that does not require gears or transmission units. The drive units may therefore be manufactured in a small installation space. Furthermore, the drive is infinitely variable, which allows for increased flexibility. In addition, the magnetic drive allows compliance with high hygiene standards, as contamination of the drive environment may be reduced to a minimum.

Encoder systems are usually used to determine the position of the rotor assemblies relative to the stator assemblies. These comprise encoder units formed on the rotor assemblies and dimensional scales formed on the stator assemblies. The encoder units are set up to read position information from the dimensional scale and use it to determine the position of the rotor assemblies relative to the stator assemblies.

Encoder systems of this type are usually installed when the machine is assembled and, in the case of very large machines with long linear drive systems, not until the machine is commissioned by employees of the machine manufacturer or machine operator. The encoder unit is attached to a rotor assembly. This is usually achieved with the aid of a screw connection, wherein this is configured in such a way that the encoder unit is fastened during assembly in a manner that is adjustable to a certain extent with regard to its spatial position. The dimensional scale, in turn, is fixed to a stator assembly. Both screw connections and adhesive connections are used in this context.

The precision of the position determinations provided by the encoder units sensitively depends on the distances and the spatial alignment between the encoder units attached to the rotor assemblies and the dimensional scales arranged on the stator assemblies. If, for example, the encoder system is operated with an insufficient distance or at an incorrect spatial angle between the encoder unit and the dimensional scale, the position determination may not provide the necessary accuracy and the control of the linear drive system may consequently be faulty.

Therefore, sufficiently trained and experienced employees of the machine manufacturer or the machine operator are required to install and align the encoder system.

### SUMMARY

The application provides a linear drive system, a rotor assembly and a stator assembly of the linear drive system.

### Examples

According to an aspect of the application, a linear drive system is provided, comprising a stator assembly and a rotor assembly, wherein the stator assembly comprises at least one guide rail on which the rotor assembly may be moved, wherein the stator assembly comprises a stator magnet assembly for providing a stator magnetic field, wherein the rotor assembly comprises a rotor magnet assembly for providing a rotor magnetic field, wherein the rotor is movable along the guide rail via a magnetic coupling between the stator magnetic field and the rotor magnetic field, wherein the drive system further comprises an encoder system having an encoder unit arranged on the rotor assembly and a dimensional scale arranged on the stator assembly, wherein the encoder unit is fixed to the rotor assembly via a locking device, wherein the encoder unit may be displaced relative to the rotor assembly along at least one predefined displacement direction via the locking device, and wherein a distance between the encoder unit and the dimensional scale may be varied via the displacement of the encoder unit along the at least one displacement direction when the rotor assembly is positioned on the guide rail.

This may provide the technical advantage that an improved linear drive system with an improved encoder system may be made available. The encoder system comprises an encoder unit, which is fixed to a rotor assembly of the drive system, and a dimensional scale, which is correspondingly fixed to a stator assembly of the drive system. The encoder unit is set up to read position information from the dimensional scale and thus to determine the absolute or incremental position of the rotor assembly relative to the stator assembly.

The encoder unit is fixed to the rotor assembly via a locking device in such a way that the encoder unit may be displaced relative to the rotor assembly along at least one predefined displacement direction via the locking device. In particular, the locking device allows for the encoder unit to be fixed to the rotor assembly by the manufacturer of the rotor assembly at the factory. Thus, a higher positioning accuracy with regard to the spatial position of the encoder unit in relation to the rotor assembly may be advantageously realized, so that the encoder unit only has to be varied in the predefined displacement direction with the aid of the locking device during the assembly of the rotor assembly in a machine in order to realize a necessary optimum spatial position of the encoder unit in relation to the dimensional scale.

By moving the encoder unit relative to the rotor assembly, a distance between the encoder unit and the dimensional scale may be varied when the rotor assembly is positioned on a guide rail of the stator assembly.

By varying the distance between the encoder unit and the dimensional scale, an optimum distance between the encoder unit and the dimensional scale may be set, which allows for optimum signal transmission or optimum reading of the position information of the dimensional scale by the encoder unit. As the locking device allows the encoder unit to be moved relative to the rotor assembly exclusively in a predefined direction of movement, the optimum distance between the encoder unit and the dimensional scale may be set simply by actuating the locking device. According to the application, this simplifies and accelerates the assembly of the machine at the machine manufacturer's and/or machine operator's premises.

Preferably, when the rotor assembly is properly positioned on the guide rail of the stator assembly, the direction of displacement is oriented perpendicular with regard to a surface of the stator assembly. Due to the vertical orientation of the displacement direction relative to the underside of the stator assembly or the drive unit, a vertical displacement of the encoder unit relative to the dimensional scale formed on the surface of the stator assembly may be achieved when the rotor assembly is arranged on the guide rails. This allows for precise adjustment of the optimum distance between the encoder unit and the dimensional scale by moving the encoder unit relative to the rotor assembly along the predefined direction of movement.

Within the meaning of the application, a dimensional scale is preferably configured as a strip-shaped unit that may be positioned on a surface of the stator assembly. The strip-shaped unit of the dimensional scale comprises position information on a surface of the strip-shaped unit, which may be read out by the encoder unit when it passes over it. The encoder system thus allows the absolute or incremental position of the rotor assembly relative to the stator assembly to be determined when the encoder unit moves along the strip-shaped unit of the dimensional scale.

According to an embodiment, the encoder unit may be displaced relative to the rotor assembly along exactly one predefined displacement direction via the locking device, the displacement direction being oriented perpendicular with regard to an underside of the encoder unit and/or perpendicular with regard to an underside of the drive unit of the rotor assembly.

This has the technical advantage that the encoder unit may be displaced exclusively along the predefined displacement direction relative to the rotor assembly, thus avoiding tilting or twisting of the encoder unit relative to the rotor assembly. The locking device may thus be used to ensure that the alignment of the encoder unit is maintained relative to the dimensional scale embodied on the stator assembly when the rotor assembly is positioned on the guide rail and that only the distance between the encoder unit and the dimensional scale may be varied by the displacement.

Preferably, the encoder unit is arranged on the rotor assembly or connected to the drive unit in such a way that the underside of the encoder unit is oriented in parallel to the underside of the drive unit. The undersides of the encoder unit and drive unit describe sides that face the stator assembly when the rotor assembly is arranged correctly on the guide rails.

Tilting of the encoder unit relative to the dimensional scale may thus be prevented by the locking device. This makes it as easy as possible to set the optimum distance between the encoder unit and the dimensional scale, which leads to optimum reading of the position information of the dimensional scale by the encoder unit without having to additionally adjust the alignment of the encoder unit relative to the dimensional scale. As described above, this allows the encoder unit to be fixed to the rotor assembly at the factory using the locking device. When assembling or installing the linear drive system, the user of the linear drive system therefore only has to set the optimum distance between the encoder unit and the dimensional scale by actuating the locking device.

The orientation of the encoder unit relative to the dimensional scale is already determined by the factory fixing of the encoder unit to the rotor assembly via the locking device and does not have to be laboriously adjusted by the user when installing the linear drive system. The installation of the linear drive system is thus drastically simplified by the encoder unit being fixed to the rotor assembly at the factory via the locking device, in that the optimum distance between the encoder unit and the dimensional scale may be set simply by actuating the locking device, without the need for any complicated alignment of the encoder unit to the dimensional scale positioned on the stator assembly.

The optimum distance between the encoder unit and the dimensional scale may depend on the respective type of encoder system and may be specified accordingly by the manufacturer. Alternatively, the optimum distance may also be set by trying out and monitoring the signal strength of the measuring signal from the encoder unit.

For the purposes of the application, factory means that a corresponding process is carried out by the manufacturer during production of the linear drive system and/or the rotor assembly and/or the encoder system and/or the stator assembly.

According to an embodiment, the locking device is configured to achieve a stepless displacement of the encoder unit relative to the rotor assembly along the direction of displacement.

The technical advantage of this is that the optimum distance between the encoder unit fixed to the rotor assembly and the dimensional scale fixed to the stator assembly may be set as precisely as possible when the rotor assembly is positioned on the guide rail of the stator assembly. Any distance between the encoder unit and the dimensional scale between a predefined minimum distance and a predefined maximum distance may be set by continuously moving the encoder unit relative to the rotor assembly.

This may be used to compensate for manufacturing tolerances of individual components of the linear drive system or different types of components of the linear drive system.

According to an embodiment, the locking device comprises a first locking part fixed to the rotor assembly and a second locking part fixed to the transmitter unit, wherein the first locking part or the second locking part has a displacement groove oriented in parallel to the direction of displacement, wherein the respective other locking part has a displacement projection which may be received by the displacement groove, and wherein the first and second locking parts may be displaced relative to one another along the direction of displacement by sliding of the displacement projection along the displacement groove.

This has the technical advantage that the most precise possible displacement of the encoder unit relative to the rotor assembly along the predefined displacement direction may be achieved. Furthermore, tilting or rotation of the encoder unit relative to the rotor assembly and tilting or rotation directions that deviate from the displacement direction may be avoided.

For this purpose, the locking device comprises two first and second locking parts that may be displaced relative with regard to one another, of which a first locking part is fixed to the rotor assembly and a second locking part is fixed to the encoder unit. The first or second locking part has a displacement groove oriented in parallel to the direction of displacement, while the other locking part has a displacement projection that may be accommodated by the displacement groove. By receiving the displacement projection through the displacement groove, it may be achieved by sliding the displacement projection along the displacement groove that the first and second locking parts may be displaced relative to each other exclusively along the displacement direction.

Tilting or rotation of the locking parts relative to one another in directions of tilt or rotation that deviate from the direction of displacement may be avoided by forming the displacement groove or displacement projection. This makes it possible to ensure that the encoder unit, which is fixed to the rotor assembly via the locking device with the two first and second locking parts, may only be moved along the predefined displacement direction.

This may be used to ensure that the alignment of the encoder unit remains unchanged when the encoder unit is moved relative to the rotor assembly. In particular when positioning the rotor assembly on the guide rail of the stator assembly, the alignment of the encoder unit relative to the dimensional scale fixed to the stator assembly may thus be maintained when the encoder unit is displaced relative to the dimensional scale and thus when the distance between the encoder unit and the dimensional scale is changed. The longitudinal alignment of the displacement groove defines the alignment of the displacement direction.

According to an embodiment, the locking device comprises an actuating unit for effecting the displacement of the first and second locking parts, wherein the actuating unit comprises a spindle element connected to the first or second locking part, and wherein the first and second locking parts are displaceable relative to each other via the spindle element.

This may provide the technical advantage that the actuating unit may be used to achieve a simple displacement of the encoder unit relative to the rotor assembly along the predefined displacement direction. For this purpose, the actuating unit has a spindle element that is rotatably connected to the first or second locking part. By actuating the spindle element, the first and second locking parts may thus be displaced relative with regard to each other. By actuating the spindle element, a displacement of the encoder unit relative to the rotor assembly along the predefined displacement direction may thus be achieved.

According to an embodiment, the actuating unit comprises an adjusting wheel connected to the spindle element as an operating element for a user, wherein the adjusting wheel may be rotated relative to the spindle element.

This may provide the technical advantage that the actuating unit of the locking device may easily be operated by a user. For this purpose, the actuating unit comprises an adjusting wheel connected to the spindle element via a threaded toothing. The adjusting wheel may be rotated relative to the spindle element. By rotating the adjusting wheel, the adjusting wheel may thus be moved along an external thread of the spindle element along a longitudinal axis of the spindle element relative to the latter. For this purpose, the spindle element may be moved into or out of an internal thread of the adjusting wheel, which leads to the displacement of the spindle element. The displacement of the spindle element may cause the first and second articulated parts to move relative with regard to each other. For this purpose, the spindle element contacts the first or second locking part and is set up to displace the respective first or second locking part accordingly when displaced along the longitudinal axis of the spindle element.

Rotating the adjusting wheel makes it easy to operate the actuating unit of the locking device and thus to move the encoder unit relative to the rotor assembly, making it easy to adjust the distance between the encoder unit and the dimensional scale.

According to an embodiment, the first and second locking parts are connected to one another via a screw element, wherein the spindle element is connected at right angles to the screw element, wherein the adjusting wheel is interlocked with an external thread of the spindle element via an internal thread, and wherein the screw element is arranged in the first or second locking part so that it can be displaced along the direction of displacement.

This may provide the technical advantage of allowing for a technically simple design of the locking device. The screw element may be used to fix the first and second locking parts to each other in such a way that the first and second locking parts may be displaced relative to each other along the predefined direction of displacement.

The spindle element is connected to the screw element at a right angle, wherein the adjusting wheel is interlocked with an external thread of the spindle element via an internal thread. By rotating the adjusting wheel, the spindle element may be moved relative to the adjusting wheel along a longitudinal axis of the spindle element.

The displacement of the spindle element causes the screw element to move along the longitudinal axis of the spindle element. This displaces the first and second locking parts relative to each other. The screw element is embodied to be perpendicular with regard to the longitudinal direction of the displacement groove and thus perpendicular with regard to the predefined displacement direction.

According to an embodiment, the spindle element is oriented in parallel to the direction of displacement.

This may provide the technical advantage that by rotating the spindle element or by rotating the adjusting wheel relative to the spindle element and by the resulting displacement of the adjusting wheel along the spindle element, a precise displacement of the first and second locking parts along the predefined displacement direction is possible.

By orienting the spindle element in parallel to the direction of displacement, it is also possible to prevent the first and second locking parts from being moved relative to each other in a direction that deviates from the direction of displacement. This ensures that the encoder unit may only be moved along the predefined displacement direction relative to the rotor assembly.

This in turn allows for the orientation or alignment of the encoder unit relative to the rotor assembly to be maintained when the encoder unit is displaced relative to the rotor assembly. As already described several times above, this in turn allows for the distance between the encoder unit and the dimensional scale embodied on the stator assembly to be easily adjusted by actuating the locking device and moving the encoder unit along the predefined displacement direction when the encoder unit is fixed to the rotor assembly at the factory via the locking device when the linear drive system is installed.

This may prevent the encoder unit from tilting or rotating relative to the rotor assembly positioned on the guide rail of the stator assembly and thus tilting of the encoder unit relative to the dimensional scale.

According to an embodiment, the first and second locking parts are arranged at a distance from each other relative to a direction perpendicular with regard to the direction of displacement.

This may provide the technical advantage that the encoder unit may be arranged on the rotor assembly in the most space-saving manner possible. For example, the locking device may be fixed to a lateral end of the rotor assembly on the rotor assembly and thus the encoder unit may be arranged on the side of the rotor assembly. The lateral arrangement of the encoder unit on the rotor assembly allows for achieving a space-saving embodiment. Furthermore, the lateral arrangement of the encoder unit on the rotor assembly means that damage to the encoder unit caused by the rotor assembly hitting external objects may be avoided.

According to an embodiment, the dimensional scale is arranged on a carrier unit, wherein the carrier unit may be detachably arranged along the stator magnet assembly on the stator assembly, and wherein a longitudinal centerline of the dimensional scale may be arranged on the stator assembly at a distance from a longitudinal centerline of the stator magnet assembly.

This may provide the technical advantage of allowing for simple positioning of the dimensional scale on the stator assembly. The dimensional scale is initially embodied on a carrier unit. The carrier unit may be detachably arranged along the stator magnet assembly on the stator assembly.

By predefining the dimensions of the carrier unit, a distance between the dimensional scale and the stator magnet assembly may be predefined by positioning the dimensional scale on the carrier unit accordingly when the carrier unit is positioned at a predefined position on the stator assembly. In this context, the distance is defined, between a longitudinal centerline of the dimensional scale and a longitudinal centerline of the stator magnet assembly.

The longitudinal centerline of the dimensional scale is aligned in parallel with regard to a longitudinal direction of the dimensional scale and is oriented centrally with regard to the dimensional scale. The longitudinal centerline of the stator magnet assembly is oriented in parallel with regard to a longitudinal direction of the stator magnet assembly and runs through a center of an upper side of the stator magnet assembly.

The upper sides of the dimensional scale and of the stator assembly in this context constitute sides that face the rotor assembly arranged on the guide rails.

By being able to predefine a position of the dimensional scale on the stator assembly via the dimensions of the carrier unit, the installation of the linear drive system and, in particular, the positioning of the dimensional scale relative to the encoder unit is facilitated. The dimensional scale may thus be simply positioned by arranging the carrier unit at a position provided for this purpose on the stator assembly.

This may be achieved, for example, by screwing the carrier unit to the stator assembly. The dimensional scale may therefore already be embodied in the factory on the carrier unit in the position provided for this purpose. When installing the linear drive system, the user therefore only has to fix the carrier unit in the corresponding position on the stator assembly, for example by screwing it in place.

By fixing the carrier unit to the stator assembly, a predefined distance of the dimensional scale relative to the stator magnet assembly of the stator assembly may be achieved through the corresponding dimensioning of the carrier unit and the corresponding positioning of the dimensional scale on the carrier unit. Due to the predefined distance of the dimensional scale relative to the stator magnet assembly of the stator assembly, the position of the dimensional scale on the stator assembly may be predefined.

If the positioning of the encoder unit on the unit and the positioning of the rotor assembly, in particular the rotor magnet assembly, relative to the stator assembly, in particular the stator magnet assembly, are known, this allows for the encoder unit to be positioned clearly relative to the dimensional scale when the rotor assembly is positioned on the guide rail fixed to the stator assembly.

It is particularly advantageous in this context that only the distance between the longitudinal centerline of the dimensional scale and the longitudinal centerline of the stator magnet assembly on the stator assembly is taken into account for the distance between the dimensional scale and the stator magnet assembly. It is thus irrelevant for the embodiment of the correct position of the dimensional scale on the stator assembly how wide the respective dimensional scale is in the specific embodiment and how wide the respective stator magnet assembly is in the specific embodiment. The only decisive factor is that the distance is selected in such a way that the dimensional scale may be positioned laterally and in parallel along the stator magnet assembly and may be used in conjunction with the encoder unit.

This eliminates the need for a complicated embodiment of the dimensional scale on the stator assembly to ensure that the dimensional scale is aligned with the encoder unit.

The dimensional scale only needs to be fixed to the stator assembly by fixing the carrier unit to the stator assembly. Due to the factory-defined dimensions of the carrier unit and the factory-defined positioning of the dimensional scale on the carrier unit, the dimensional scale is automatically arranged in the intended position on the stator assembly by fixing the carrier unit to the stator assembly.

According to an embodiment, the encoder unit is fixed to the rotor assembly with the aid of the locking device in such a way that a longitudinal centerline of a detection unit of the encoder unit facing the dimensional scale is at a distance from a longitudinal centerline of the rotor magnet assembly.

This may provide the technical advantage that the encoder unit may assume a predefined and exact position on the locking device and thus also on the rotor assembly.

This allows for precise alignment of the encoder unit relative to the rotor assembly. In particular, the manufacturing tolerances of the rotor assembly, the locking device and the encoder unit may be precisely matched to one another so that the locking device may be fixed very precisely to the rotor assembly and the encoder unit may then be fixed very precisely to the locking device.

At best, this may be done in the factory by the manufacturer of the rotor assembly, so that very precise aids, which are not usually available when the machine is assembled by the machine manufacturer or the machine user, may be used for precise alignment of the encoder unit relative to the rotor assembly. This eliminates the need for laborious alignment of the encoder unit relative to the dimensional scale.

It is particularly advantageous in this context that the distance between the encoder unit and the rotor magnet assembly only takes into account the distance between the longitudinal centerline of the encoder unit, in particular the longitudinal centerline of a detection unit of the encoder unit facing the dimensional scale, and the longitudinal centerline of the rotor magnet assembly.

It is therefore irrelevant for the embodiment of the correct position of the encoder unit on the rotor assembly how wide the respective encoder unit is in the specific embodiment and how wide the respective rotor magnet assembly is in the specific embodiment. The only decisive factor is that the distance is selected in such a way that the encoder unit and the interposed locking device may be positioned laterally next to the rotor magnet assembly and may be used in conjunction with the dimensional scale.

According to an embodiment, the longitudinal centerline of the stator magnet assembly and the longitudinal centerline of the rotor magnet assembly are congruent along an x-axis and aligned in parallel to each other along a y-axis.

This ensures optimum magnetic force transmission between the rotor magnet assembly and the stator magnet assembly. The dimensional scale and the encoder unit are arranged in relation to the x-axis on a joint side to the side of the longitudinal centerline of the stator magnet assembly and the longitudinal centerline of the rotor magnet assembly, so that the encoder unit may use the dimensional scale to determine the position.

The distance between the longitudinal centerline of the dimensional scale and the longitudinal centerline of the stator magnet assembly and the distance between the longitudinal centerline of the encoder unit and the longitudinal centerline of the rotor magnet assembly have an identical length.

The technical advantage of this is that the congruent and parallel arrangement of the rotor magnet assembly and the stator magnet assembly and the formation of the aforementioned distances with an identical length means that the encoder unit is positioned exactly centrally above the dimensional scale. Accordingly, it is possible to determine the exact position using the encoder unit in conjunction with the dimensional scale.

The fact that the distances mentioned have an identical length results in the further advantage that when using an encoder unit with a different dimension than that of an original encoder unit and a resulting change in the distance between the longitudinal centerline of a detection unit of the now used encoder unit facing the dimensional scale and the longitudinal centerline of the stator magnet assembly, the positioning of the dimensional scale also changes automatically. According to the aforementioned features, this is then positioned in such a way that a longitudinal centerline of the dimensional scale is arranged on the stator assembly at a distance from a longitudinal centerline of the stator magnet assembly that corresponds to the distance between the longitudinal centerline of a detection unit of the now inserted encoder unit facing the dimensional scale and the longitudinal centerline of the rotor magnet assembly. The new position of the dimensional scale on the stator assembly is correspondingly easy to find.

According to an embodiment, the encoder system is configured as a magnetic encoder system or an optical encoder system or a capacitive encoder system.

This may provide the technical advantage that a precise encoder system may be provided for determining the position of the rotor assembly relative to the stator assembly.

According to an embodiment, the encoder system is configured as an incremental encoder system and/or an absolute encoder system.

This may provide the technical advantage that the position of the rotor assembly may be precisely determined relative to the stator assembly.

According to an embodiment, the stator assembly has two guide rails running parallel to each other, with the dimensional scale being arranged between the two guide rails on the stator assembly.

This may provide the technical advantage that the encoder system may be arranged between the two guide rails of the stator assembly by configuring the dimensional scale between the two guide rails of the stator assembly. This prevents damage to the encoder system caused by impact from external objects that are arranged next to the guide rails on the stator assembly. The two guide rails also ensure that the rotor assembly moves safely.

According to a further aspect, a rotor assembly with an encoder unit of an encoder system for a linear drive system according to any one of the preceding embodiments is provided.

This may achieve the technical advantage that an improved rotor assembly may be provided with an encoder unit of an encoder system with the technical advantages described above.

According to a further aspect, a stator assembly having a dimensional scale of an encoder system for a linear drive system according to any one of the preceding embodiments is provided.

This may achieve the technical advantage that a stator assembly with a dimensional scale of an encoder system may be provided with the technical advantages described above.

### BRIEF DESCRIPTION OF THE DRAWINGS

The application is described in more detail with reference to the attached figures, in which:

FIG. 1 is a schematic perspective view of a linear drive system having a stator assembly and a rotor assembly according to an embodiment;

FIG. 2 is a schematic front view of the linear drive system having a stator assembly and a rotor assembly according to an embodiment;

FIG. 3 is an enlarged view of the encoder unit and the dimensional scale from FIG. 2;

FIG. 4 is a schematic front view of a rotor assembly having an encoder unit according to an embodiment;

FIG. 5 is a schematic top view of the rotor assembly having an encoder unit according to an embodiment;

FIG. 6 is a schematic side view of the rotor assembly having an encoder unit according to an embodiment; and

FIG. 7 is a schematic bottom view of the rotor unit having an encoder unit according to an embodiment.

### DETAILED DESCRIPTION

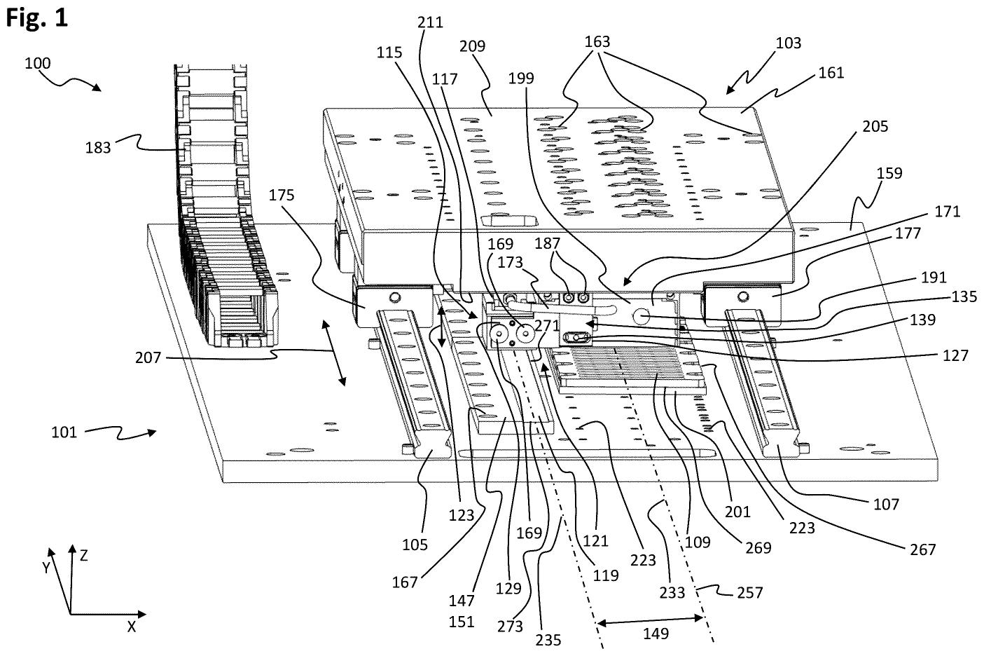

FIG. 1 shows a schematic perspective view of a linear drive system 100 comprising a stator assembly 101 and a rotor assembly 103 according to an embodiment.

The linear drive system 100 shown comprises a stator assembly 101 and a rotor assembly 103. The stator assembly 101 comprises at least one guide rail 105, 107 on which the rotor assembly 103 may be moved. The stator assembly further comprises a stator magnet assembly 109. The rotor assembly 103 comprises a rotor magnet assembly 111 integrated in a drive unit 205.

The rotor magnet assembly 111 may be used to generate a rotor magnetic field for the rotor assembly 103. A corresponding stator magnetic field of the stator assembly 101 may be generated via the stator magnet assembly 109. The rotor assembly 103 may be controlled along the first and second guide rails 105, 107 via a magnetic coupling and may thus be moved in the longitudinal direction 207.

The linear drive system 100 also comprises an encoder system 115 having an encoder unit 117 and a dimensional scale 119. According to the application, the encoder unit 117 is fixed to the rotor assembly 103, while the dimensional scale 119 is arranged on the stator assembly 101. The position of the rotor assembly 103 relative to the stator assembly 101 may be determined via the encoder system 115.

In the embodiment shown, the stator assembly 101 comprises a stator base 159. In the embodiment shown, the stator base 159 is configured as a base plate.

A plurality of positioning holes 223 is formed in the stator base 159. The stator magnet assembly 109 may be attached to the stator base via the positioning holes 223.

In the embodiment shown, the stator assembly 101 comprises guide rails 105, 107 in the form of a first guide rail 105 and a second guide rail 107. The guide rails 105, 107 are arranged in parallel to and at a distance from one another on the stator base 159.

In the embodiment shown, the stator magnet assembly 109 is arranged between the first and second guide rails 105, 107 along a longitudinal direction 207 of the guide rails 105, 107 corresponding to the y-direction. The stator magnet assembly 109 may e.g. comprise a plurality of permanent magnets arranged along the longitudinal direction 207 of the guide rails 105, 107.

In relation to a direction perpendicular with regard to the longitudinal direction 207, the dimensional scale 119 is embodied at a distance from the stator magnet assembly 109. The dimensional scale 119 is preferably aligned in parallel with regard to the stator magnet assembly 109. The parallelism of the dimensional scale 119 to the stator magnet assembly 109 in this context refers to a longitudinal centerline 235 of the dimensional scale 119 and to a corresponding longitudinal centerline 233 of the stator magnet assembly 109, which are arranged in parallel with regard to one another in each case. The longitudinal centerline 235 of the dimensional scale 119 is oriented in parallel with regard to a longitudinal direction 255 of the dimensional scale 119 and runs through a center of an upper side 241 of the dimensional scale 119. The longitudinal centerline 233 of the stator magnet assembly 109 is correspondingly oriented in parallel with regard to a longitudinal direction 257 of the stator magnet assembly 109 and runs through a center of an upper side 253 of the stator magnet assembly 109.

Preferably, the longitudinal direction 255 of the dimensional scale 119 and the longitudinal direction 253 of the stator magnet assembly 109 are oriented in parallel to the longitudinal direction 207 of the guide rails 105, 107.

In the embodiment shown, the dimensional scale 119 is embodied as a band-shaped unit which extends along the longitudinal direction 207 in parallel with regard to the stator magnet assembly 109 and with regard to the first and second guide rails 105, 107. The dimensional scale 119 comprises two long sides 271 and two short sides 273. The longitudinal direction 255 of the dimensional scale 119 is oriented in parallel with regard to the long sides 271.

The stator magnet assembly 109 is rectangular having two long sides 267 and two short sides 269. The longitudinal direction 257 of the stator magnet assembly 109 is oriented in parallel to the long sides 267 of the stator magnet assembly 109.

In the embodiment shown, the dimensional scale 119 is arranged on a carrier unit 147. The carrier unit 147 comprises a carrier plate 151. The carrier plate 151 comprises a plurality of fixing openings 167.

The carrier unit 147 or the carrier plate 151 with the dimensional scale 119 arranged thereon may be fixed to the stator base 159 of the stator assembly 101 with the aid of corresponding fixing elements, not shown in FIG. 1.

In the embodiment shown, the dimensional scale 119 is arranged at a distance 149 from the stator magnet assembly 109. The distance 149 is defined at a distance between the longitudinal centerline 235 of the dimensional scale 119 and the longitudinal centerline 133 of the stator magnet assembly 109. Due to the parallel alignment of the longitudinal centerline 235 of the dimensional scale 119 to the longitudinal centerline 233 of the stator magnet arrangement 109, the distance 149 is constant over the entire length of the dimensional scale 119 and/or the stator magnet assembly 109.

The distance 149 between the longitudinal centerline 235 of the dimensional scale 119 and the longitudinal centerline 233 of the stator magnet arrangement 109 is preferably dimensioned in such a way that the dimensional scale 119 is arranged directly below the encoder unit 117 when the rotor assembly 103 is arranged on the guide rails 105, 107.

In the embodiment shown, the encoder unit 117 of the encoder system 115 is arranged on a housing unit 171 of the drive unit 205 of the rotor assembly 103. In the embodiment shown, the encoder unit 117 is arranged laterally on the housing unit 171 of the drive unit 205 with respect to the longitudinal direction 207 or at a distance from the housing unit 171 with respect to a direction perpendicular with regard to the longitudinal direction 207.

According to the application, the encoder unit 117 is arranged on the rotor assembly 103 and in particular on the drive unit 205 of the rotor assembly 103 via a locking device 121. The encoder unit 117 may be displaced relative to the rotor assembly 103 along at least one predefined displacement direction 123 via the locking device 121.

In the embodiment shown, the encoder unit 117 is displaceable along exactly one predefined displacement direction 123 relative to the rotor assembly 103. The precisely one predefined displacement direction 123 is in this context aligned perpendicular with regard to a rotor base 161 of the rotor assembly 103 and at the same time perpendicular with regard to an underside 213 of the encoder unit 117. When the rotor assembly 103 is positioned on the guide rails 105, 106 of the stator base 101, the rotor base 161 and the drive unit 205 are aligned in parallel with regard to a plate-shaped stator base 159 of the stator assembly 101.

When the rotor assembly 103 is positioned on the guide rails 105, 107 of the stator assembly 101, a distance between the encoder unit 117 and the dimensional scale 119 of the encoder system 115 arranged on the stator assembly 101 may thus be varied by displacing the encoder unit 117 along the displacement direction 123.

The signal detection by the encoder unit 117 may be optimized by varying the distance between the encoder unit 117 and the dimensional scale 119. The encoder unit 117 is set up to read out or detect position information of the dimensional scale 119. The detection of the position information by the encoder unit 117 may sensitively depend on the distance between the encoder unit 117 and the dimensional scale 119. For optimum signal detection by the encoder unit 117, there may thus be an optimum distance between the encoder unit 117 and the dimensional scale 119.

When a user of the linear drive system 100 actuates the locking device 121, the distance between the encoder unit 117 and the dimensional scale 119 may be set to the optimum distance at which optimum signal detection by the encoder unit 117 is possible by moving the encoder unit 117 along the direction of movement 123.

For this purpose, the locking device 121 comprises a first locking part 127 and a second locking part 129. The first locking part 127 is firmly connected to the rotor assembly 103, while the second locking part 129 is connected to the encoder unit 117.

In the embodiment shown, the first locking part 127 is fixed to the housing unit 171 of the drive unit 205 of the rotor assembly 103 via two second fixing elements 187, which may be configured as screw elements, for example. The second locking part 129 is also fixed to the encoder unit 117 via two first fixing elements 169.

According to an embodiment, the first and second locking parts 127, 129 are displaceable relative to one another along the direction of displacement 123. By displacing the first and second locking parts 127, 129 relative to one another along the displacement direction 123, the encoder unit 117 may thus be displaced relative to the rotor assembly 103.

When the rotor assembly 103 is positioned on the guide rails 105, 107, moving the encoder unit 117 relative to the rotor assembly 103 by moving the first and second locking parts 127, 129 relative to one another allows the distance between the encoder unit 117 and the dimensional scale 119 arranged on the stator assembly 101 to be varied.

According to the embodiment shown, the locking device 121 comprises an actuating unit 135. With the aid of the actuating unit 135, the first and second locking parts 127, 129 may be displaced relative to each other along the displacement direction 123. In the embodiment shown, the actuating unit 135 comprises an adjusting wheel 139 with the aid of which a user may cause the first and second locking parts 127, 129 to be displaced relative to one another.

In the embodiment shown, the encoder unit 117 is connected to the drive unit 205 of the rotor assembly 103 via a connection cable 173. Data transmission of the signal detection or the position data of the encoder unit 117 to the drive unit 205 is possible via the connection cable 173.

This is particularly advantageous if the encoder unit 117 is already positioned on the rotor assembly 103 at the factory by the manufacturer of the rotor assembly 103 with the aid of the locking device 121. The encoder unit 117 may then also be wired directly with regard to its voltage supply and the data connection, without the encoder unit 117 having to be additionally wired when the machine is assembled by the machine manufacturer and/or the machine user. In this case, only a common voltage and data connection of the rotor assembly 103 and the encoder unit 117 to a higher-level voltage supply and control system is required during commissioning of the machine, which may be routed via a cable guide 183, for example.

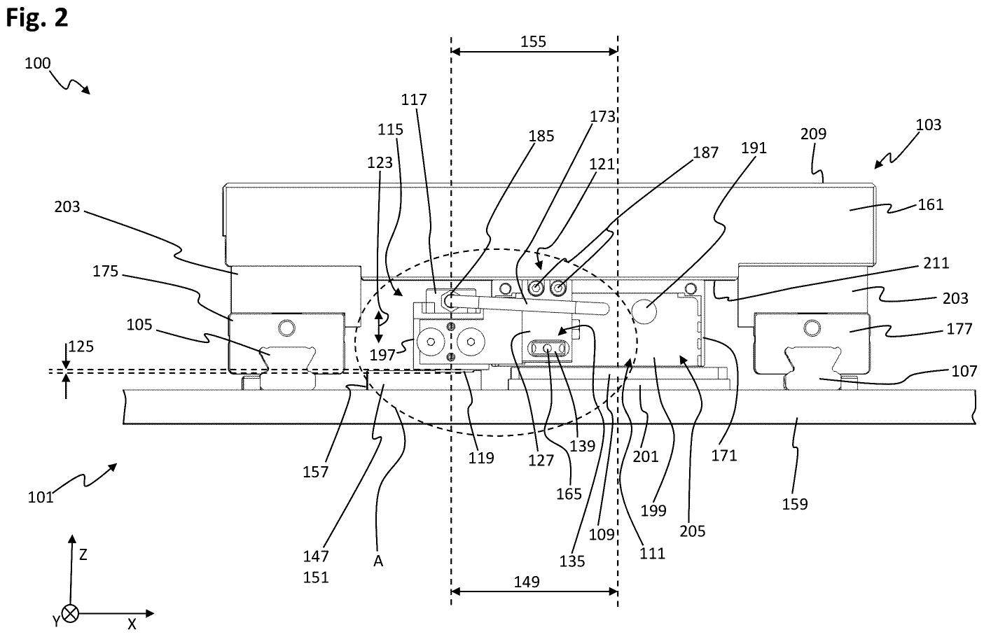

According to the application, the manufacturer of the drive unit 205 already attaches the encoder unit 117 to the drive unit 205 at the factory during production of the drive unit 205 via the locking device 121. In this context, the manufacturer also defines a distance between the encoder unit 117 and the rotor magnet assembly 111, which is part of the drive unit 205. For a precise description of the distance, please refer to the description of FIG. 2.

The rotor assembly 103 and the stator assembly 101 are then manufactured by a machine manufacturer. For this purpose, the drive unit 205 including the encoder unit 117 is fixed to the rotor base 161. The rotor base 161 is also provided with at least the guide elements 175, 177. The dimensions and detailed embodiment of the rotor assembly are determined by the machine manufacturer. Furthermore, the stator assembly 101 is manufactured by the machine engineer.

During assembly, the stator magnet assembly 109 provided by the manufacturer of the drive unit 205 and the dimensional scale 119 including the support structure 147 may be arranged on the stator base 159 at the predefined distance 149 between the dimensional scale 119 and the stator magnet assembly 109 by the machine engineer or an end user.

For this purpose, the drive unit 205 comprises a partially illustrated connection wiring 191 on a front cover 199 of the housing unit 171. The electrical and data connection of the rotor assembly 103 is made possible with the aid of the connection wiring 191.

In the embodiment shown, the drive unit 205 is arranged on an underside of the rotor base 161. Furthermore, two guide elements 175, 177 are embodied on the underside of the rotor base 161.

The rotor assembly 103 is arranged on the first guide rail 105 of the stator assembly 101 via a first guide element 175 and on the second guide rail 107 of the stator base 101 via the second guide element 177.

The first and second guide elements 175, 177 may be used to move the rotor 103 on the first and second guide rails 105, 107 of the stator base 101 along the longitudinal direction 207 of the guide rails 105, 107 relative to the stator base 101 by controlling the rotor magnetic field.

In the embodiment shown, the rotor base 161 comprises a plurality of positioning holes 163. In the embodiment shown, the positioning holes 163 are shown only on an upper surface 209 of the rotor base 161.

In addition, however, corresponding positioning holes 163 may be arranged on the underside 211 of the rotor base 161. In addition to the drive unit 205 and the guide elements 175, 177, additional superstructures may be fixed to the rotor base 161 via the positioning holes 163.

In the embodiment shown, the stator magnet assembly 109 is arranged at the stator base 159 via a fixing base 201.

FIG. 2 shows a schematic front view of the linear drive system 100 with a stator assembly 101 and a rotor assembly 103 according to an embodiment.

The embodiment shown in FIG. 2 is based on the embodiment in FIG. 1. The linear drive system 100 comprises all the features described there.

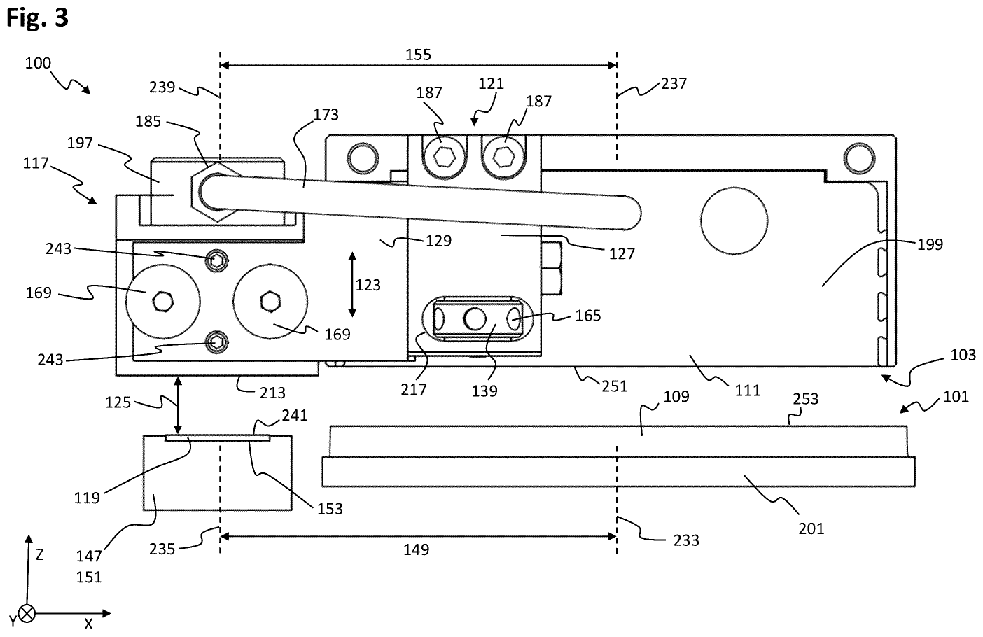

FIG. 2, in conjunction with FIG. 3, shows a more detailed description of the locking device 121, with the aid of which the encoder unit 117 is fixed to the rotor assembly 103. The locking device 121 comprises the aforementioned first and second locking parts 127, 129.

The first locking part 127 is fixed to the housing unit 171 of the drive unit 205 of the rotor assembly 103 via the second fixing elements 187. The second locking part 129 is fixed to the encoder housing 197 of the encoder unit 117 via the two first fixing elements 169.

The first and second locking parts 127, 129 may be displaced relative to one another along the predefined displacement direction 123 via the actuating unit 135. When the rotor assembly 103 is arranged on the guide rails 105, 107 of the stator assembly 101, the predefined displacement direction 123 runs perpendicular with regard to the stator base 159 of the stator assembly 101 and thus in parallel to the z-axis of the coordinate system shown.

The distance 125 between the encoder unit 117 and the dimensional scale 119 fixed to the stator assembly 101 may be achieved by moving the two locking parts 127, 129 relative to one another along the direction of movement 123 and moving the encoder unit 117 relative to the rotor assembly 103 accordingly.

In the embodiment shown, the actuating unit 135 comprises an adjusting wheel 139. By rotating the adjusting wheel 139, the first and second locking parts 127, 129 may be displaced relative to one another along the displacement direction 123. In the embodiment shown, the adjusting wheel 139 has a plurality of adjusting openings 165.

According to a further embodiment, the adjusting wheel 139 may also be configured as a knurled wheel. In this embodiment, the adjusting openings 165 may be replaced by a structuring of an outer surface of the adjusting wheel 135.

The adjusting wheel 139 may be caused to rotate by a user in order to achieve the displacement of the first and second locking parts 127, 129 or the encoder unit 117. The adjusting openings 165 may be used, for example, to insert a screwdriver in order to rotate the adjusting wheel 139.

In the installed state in which the rotor assembly 103 is positioned on the guide rails 105, 107 of the stator assembly 101, the actuating unit 135 and in particular the adjusting wheel 139 may be reached from the side of the rotor assembly 103 in order to be able to vary the distance between the encoder unit 117 and the dimensional scale 119. The adjusting wheel 139 may thus be easily reached by the user in the installed state, in which the rotor assembly 103 is positioned on the guide rails 105, 107. For this purpose, the adjustment openings 165 may be used, for example, as insertion openings for a screwdriver or a similar tool in order to rotate the adjustment wheel 137. This allows the user easy access to the actuating unit 135 of the locking device 121 in order to be able to vary the distance 125 between the encoder unit 117 and the dimensional scale 119.

In the embodiment shown, the connection cable 173 of the encoder unit 117 is fixed to the encoder housing 197 via a connector element 185.

In the embodiment shown, the first and second guide elements 175, 177 are fixed to the underside 211 of the rotor base 161 by two support elements 203.

In the embodiment shown, the carrier unit 147, on which the dimensional scale 119 is embodied, is configured as a carrier plate 151 with a receiving groove 153. The dimensional scale 119 is arranged in the receiving groove 153. The receiving groove 153 and the dimensional scale 119 arranged therein are arranged on the stator assembly 101 in such a way that the longitudinal centerline 235 of the dimensional scale 119 is arranged at a distance 149 from the longitudinal centerline 233 of the stator magnet assembly 109.

The carrier unit 147 or the carrier plate 151 are configured as an elongated unit and are embodied along the longitudinal direction 207 or the y-direction of the stator base 159 of the stator assembly 101.

By positioning the carrier unit 147 accordingly in the position provided for this purpose on the stator base 159 of the stator assembly 101, a positioning of the dimensional scale 119 on the stator base 150 of the stator assembly 101 may be predefined.

The positioning of the carrier unit 147 on the stator base 159 may be achieved, for example, by screwing the carrier unit 147 onto the stator base 159.

As may be seen in FIG. 1, the carrier unit 147 may be configured with corresponding positioning holes 136 for this purpose. The stator base 159 may be provided with corresponding further positioning holes 223, with the aid of which it is possible to screw the carrier unit 147 to the stator base 159.

Similarly, the stator magnet assembly 109 may be fixed in predefined positions on the stator base 159 via corresponding positioning holes 223.

Preferably, the distance 149 between the longitudinal centerline 235 of the dimensional scale 119 and the longitudinal centerline 233 of the stator magnet assembly 109 corresponds to a distance 155 between a longitudinal centerline 239 of the encoder unit 117 and a longitudinal centerline 237 of the rotor magnet assembly 111.

The longitudinal centerline 239 of the encoder unit 117 is aligned along a longitudinal direction 247 of the encoder unit 117 and runs through a center point of the encoder unit 117.

Similarly, the longitudinal centerline 237 of the rotor magnet assembly 111 is aligned parallel to a longitudinal direction 249 of the drive unit 205 and extends through a center of the underside of the rotor magnet assembly 111.

By rendering the distance 149 between the longitudinal centerline 235 of the dimensional scale 119 and the longitudinal centerline 233 of the stator magnet assembly 109 and the distance 155 between a longitudinal centerline 239 of the encoder unit 117 and a longitudinal centerline 237 of the rotor magnet assembly 111 equal, it may be achieved that, when the rotor assembly 103 is positioned on the guide rails 105, 107, the encoder unit 117 is arranged directly above the dimensional scale 119.

For this purpose, the distance 155 is determined precisely during manufacturing. This is primarily provided by the configuration of the encoder unit 117, the rotor magnet assembly 111 and the locking device 121. According to the application, the encoder unit 117 is arranged next to the rotor magnet assembly 111 in relation to the longitudinal direction 249 of the drive unit 205 or is arranged at a distance from the rotor magnet assembly 111 in relation to a direction perpendicular with regard to the longitudinal direction 249.

If the distance 155 between the longitudinal centerline 239 of the encoder unit 117 and a longitudinal centerline 237 of the rotor magnet assembly 111 is known, the dimensional scale 119 is arranged on the stator assembly 101 at a distance 149 from one another with the aid of the carrier unit 147 and the stator magnet assembly 109.

This may, for example, be done initially by providing the stator base 159 with corresponding positioning holes 223 at predefined positions on the stator base 159.

By positioning the corresponding further positioning holes 223 on the stator base 159, the positioning of the support base 147 and thus the positioning of the dimensional scale 119 embodied on the support base 147 relative to the stator magnet assembly 109 may thus be predefined.

Said predefinition of the position of the dimensional scale 119 on the stator assembly 101 relative to the stator magnet assembly 109 by the predefined formation of the carrier unit 147 on the stator base 159 enables easy positioning of the dimensional scale 119 on the stator assembly 101, which may be achieved simply by fixing the carrier unit 147 at the designated locations of the further positioning holes 223 on the stator base 159 of the stator assembly 101.

The actual positioning of the support structure 147 including the dimensional scale 119 and the stator magnet assembly 109 on the stator base 159 at the predefined distance 149 may be carried out by a mechanical engineer or an end user of the drive system 100 during the final installation of the drive system 100.

By matching the two distances 149, 155, the dimensional scale 119 may thus be arranged directly in the optimum position on the stator base 159, which allows for optimum alignment of the dimensional scale 119 to the encoder unit 117.

Preferably, the dimensional scale 119 is arranged on the stator base 159 in such a way that a parallel alignment of the longitudinal direction 255 of the dimensional scale 119 to the longitudinal direction 247 of the encoder unit 117 is achieved.

With the aid of the locking device 121, the encoder unit 117 is configured at the factory in the position provided for it on the rotor assembly 103 when the rotor assembly 103 is manufactured and is spaced at a distance 155 from the rotor magnet assembly 11.

The positioning of the carrier unit 147 and the dimensional scale 119 arranged thereon on the stator base 159 of the stator assembly 101 may thus, as described above, also already be defined at the factory. This is primarily done by defining the positioning of the dimensional scale 119 with the predefined distance 149 to the stator magnet assembly 109. The alignment of the encoder unit 117 to the dimensional scale 119 may therefore already be optimally predefined at the factory by defining the distances 149, 155.

However, since the carrier unit 147 may be detachably fixed to the stator base 159 of the stator assembly 101 via the corresponding fixing elements, the dimensional scale 119 need not already be formed on the stator assembly 101 at the factory in order to predefine the positioning of the dimensional scale 119 on the stator assembly 101.

The machine builder or the end user may achieve this as desired by accordingly arranging the carrier unit 147 on the stator assembly 101 itself. However, the predefined distances 149, 155 and the thus predefined positioning of the dimensional scale 119 relative to the stator magnet assembly 109 ensure that the dimensional scale 119 is arranged on the stator assembly 101 via the fixing of the carrier unit 147 in such a way that, when the rotor assembly 103 is arranged on the guide rails 105, 107 of the stator assembly 101, an optimized alignment of the encoder unit 117 to the dimensional scale 119 is achieved.

In this context, it is, of course, assumed that the stator magnet assembly 109 is arranged on the stator base 159 in such a way that, when the rotor assembly 103 is positioned on the guide rails 105, 107, the rotor magnet assembly 111 and the stator magnet assembly 109 are optimally aligned with one another, preferably directly above one another.

As already mentioned with respect to FIG. 1, the locking device enables the encoder unit 117 to be displaced relative to the rotor assembly 113 along the predefined displacement direction 123. When the rotor assembly 103 is arranged on the stator assembly 101, the predefined displacement direction 123 runs perpendicular with regard to a surface of the stator base 159 and thus in parallel to the z-direction of the coordinate system shown.

In that the locking device 121 permits displacement of the encoder unit 117 relative to the rotor assembly 103 only in the predefined displacement direction 123 and prevents tilting or rotating of the encoder unit 117 relative to the rotor assembly 103 about tilting or rotation directions deviating from the displacement direction 123, the alignment of the encoder unit 117 with the dimensional scale 119 formed on the stator assembly 101 is maintained when the encoder unit 117 is displaced along the displacement direction 123.

By not causing tilting or twisting of the encoder unit by actuating the locking device and by moving the encoder unit 117 along the moving direction 123, a uniform distance 125 between the encoder unit 117 and the dimensional scale 119 may be achieved over an entire course of an underside 213 of the encoder unit 117 by moving the encoder unit 117 along the moving direction 123.

FIG. 3 shows an enlarged view of the encoder unit 117 and the dimensional scale 119 from FIG. 2.

In FIG. 3, section A of FIG. 2 is shown in detail.

As in FIG. 2, the rotor assembly 103 is positioned on the guide rails 105, 107. When the rotor assembly 103 is positioned on the guide rails 105, 107, the encoder unit 117 is arranged directly above the dimensional scale 119.

By displacing the encoder unit 117 relative to the rotor assembly 103 along the displacement direction 123, the distance 125 between the encoder unit 117 and the dimensional scale 119 arranged on the stator assembly 101 may be varied.

This allows the optimum distance 125 between the encoder unit 117 and the dimensional scale 119 to be set for signal detection by the encoder unit 117. This enables precise position determination to be achieved by the encoder unit 117.

According to the application, the distance 125 is defined between the lower side 213 of the encoder unit 117 and an upper side 241 of the dimensional scale 119 when the rotor assembly 103 is arranged on the guide rails 105, 107 of the stator assembly 101.

The lower side 213 of the encoder unit 117 and the lower side 225 of the drive unit 205 of the rotor assembly 103 face the stator assembly 101 when the rotor assembly 103 is positioned on the guide rails 105, 107, while the upper side 241 of the dimensional scale 119 faces the lower side 213 of the encoder unit 117.

By moving the encoder unit 117 along the displacement direction 123 and adjusting the distance 125 between the encoder unit 117 and the dimensional scale 119 accordingly, tolerances in the production of the linear drive system 100 may be compensated for.

An optimum distance 125 between encoder unit 117 and dimensional scale 119 may be 0.15 mm±0.1 mm, for example.

The total stroke of the locking device 121, by which the encoder unit 117 may be displaced along the displacement direction 123, may be 1-2 mm, for example.

Optimum signal detection requires that when the rotor assembly 103 is positioned on the guide rails 105, 107, the encoder unit 117, in particular the underside 213 of the encoder unit 117, is aligned in parallel to the dimensional scale 119.

For this purpose, the encoder unit 117 is fixed to the rotor assembly 103 via the locking device 121 in such a way that the underside 213 of the encoder unit 103 is oriented in parallel to the underside 225 of the drive unit 205 of the rotor assembly 103.

Since the drive unit 205 is embodied on the underside 211 of the plate-shaped rotor base 161, the underside 213 of the encoder unit 117 is thus also oriented in parallel to the underside 211 of the rotor base 161.

The predefined displacement direction 123 is thus oriented perpendicular with regard to the underside 213 of the encoder unit 117. This allows for ensuring that the orientation of the underside 213 of the encoder unit 117 is maintained unchanged when the encoder unit 117 is displaced along the displacement direction 123.

The parallel alignment of the lower side 213 of the encoder unit 117 to the upper side 241 of the dimensional scale 119 when the rotor assembly 103 is positioned on the guide rails 105, 107 of the stator assembly 101 therefore remains unchanged when the encoder unit 117 is displaced by actuating the locking device 121.

This ensures optimum signal detection of the position information of the dimensional scale 119 by the encoder unit 117.

The displacement of the encoder unit 117 relative to the rotor assembly 103 and thus relative to the dimensional scale 119 arranged on the stator assembly 101 may be achieved by actuation of the actuating unit 135 of the locking device 121 by a user.

In the embodiment shown, the actuating unit 135 of the locking device 121 comprises an adjusting wheel 129 with adjusting openings 165 for easy operation by a user. According to an embodiment, the adjusting wheel 129 is connected to a spindle element not shown in FIG. 3. The spindle element is in turn connected to the first and second locking parts 127, 129. The spindle element may be displaced along a longitudinal axis of the spindle element parallel to the displacement direction 123 by rotation of the adjusting wheel 129 by the user.

The first and second locking parts 127, 129 may thus be displaced relative to one another by the action of the spindle element. This allows for the encoder unit 117 to be displaced relative to the rotor assembly 103, thereby varying the distance 125 between the encoder unit 117 and the dimensional scale 119.

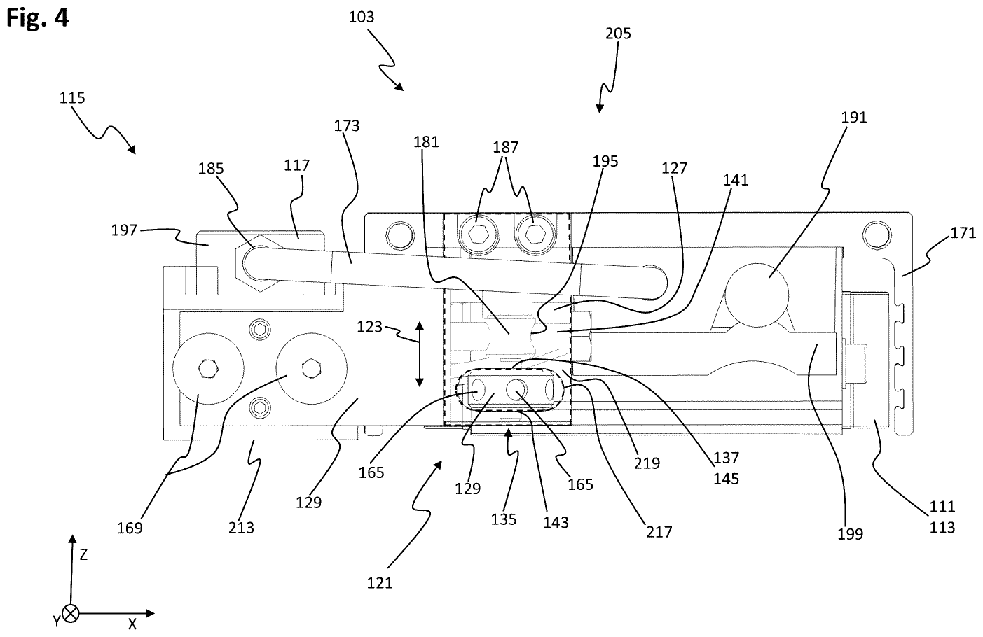

For a detailed description of the operation of the locking device 121, please refer to the description of FIG. 4.

Furthermore, two threaded screws 243 are embodied at the second locking part 129. The threaded screws 243 are each screwed into a thread formed in the second locking part 129 and extending through the second locking part 129 and contact the encoder unit 117. By screwing the threaded screws 243 into the thread or by screwing them out of the thread, the threaded screws 243 may cause the encoder unit 117 to tilt about the x-axis of the coordinate system shown.

This allows the encoder unit 117 to be tilted relative to the rotor assembly 103 to achieve parallel alignment of the underside 213 of the encoder unit 117 relative to the underside 225 of the drive unit 205 and the underside 211 of the rotor base 161 of the rotor assembly 103. The threaded screws 243 may be used to compensate for tolerances in the manufacture of the rotor assembly 103 and/or the locking device 121 and to achieve an exact alignment of the encoder unit 117 relative to the rotor assembly 103.

In an embodiment not shown, further threaded pins may be embodied between the first locking part 127 and the second locking part 129. These further threaded pins may each be screwed into a thread embodied in the first locking part 127 and extending through the first locking part 127 and contact the second locking part 129. By screwing the further threaded pins into the thread or by screwing them out of the thread, the further threaded pins may cause the second locking part 129 and thus also the encoder unit 117 to tilt about the y-axis of the coordinate system shown.

As a result, the encoder unit 117 may be tilted relative to the rotor assembly 103 in order to achieve a parallel alignment of the underside 213 of the encoder unit 117 relative to the underside 225 of the drive unit 205 and the underside 211 of the rotor base 161 of the rotor assembly 103. The further threaded pins may thus alternatively or additionally compensate for tolerances in the manufacture of the rotor assembly 103 and/or the locking device 121 and achieve an exact alignment of the encoder unit 117 relative to the rotor assembly 103.

The encoder unit 117 may be aligned via the threaded screws 243 and/or the other threaded screws, in particular at the factory when the linear drive system 100 is manufactured. The user may thus be provided with a rotor assembly 103 with a precisely aligned encoder unit 117.

FIG. 4 shows a schematic front view of a rotor assembly 103 with an encoder unit 117 according to an embodiment.

The embodiment shown in FIG. 4 is based on the embodiments of FIGS. 1, 2 and 3. The features described for FIGS. 1, 2 and 3 are not described again in detail below.

FIG. 4 shows a front end 215 of the drive unit 205. The encoder unit 117 is attached to the drive unit 205 via the locking device 121.

Furthermore, the encoder unit 117 is arranged next to the drive unit 205 with respect to the longitudinal direction or with respect to the y-direction of the coordinate system shown.

In the embodiment shown, the first and second locking parts 127, 129 are also arranged at a distance from one another with respect to the y-direction.

In FIG. 4, the first locking part 127 is shown in semi-transparent form. This serves to show the components of the actuating unit 135 arranged in an interior of the locking part 127.

In the embodiment shown, the actuating unit 135 comprises the aforementioned spindle element 137 and the adjusting wheel 139 already shown in FIGS. 1 to 3. In the embodiment shown, the spindle element 137 runs parallel to the displacement direction 123. The spindle element 137 comprises an external thread 145, not shown in FIG. 3.

The adjusting wheel 139 comprises an internal thread 143, which is not shown in FIG. 4, either. The adjusting wheel 139 is interlocked with the external thread 145 of the spindle element 137 via the internal thread 143. The adjusting wheel 139 may thus be rotated relative to the spindle element 137.

In the embodiment shown, the locking device 121 further comprises a screw element 141. The first and second locking parts 127, 129 are fixed to each other via the screw element 141. In the embodiment shown, the screw element 141 extends in a direction perpendicular with regard to the displacement direction 123 for this purpose.

In the embodiment shown, the spindle element 137 also comprises a coupling element 181. Coupling of the spindle element 137 with the screw element 141 is made possible via the coupling element 181. For this purpose, the screw element 141 is guided through a feed-through opening 195 of the coupling element 181.

A right-angled coupling between the screw element 141 and the spindle element 137 is thus achieved via the coupling element 181.

In the embodiment shown, the adjusting wheel 139 is arranged in a guide recess 217 of the first locking part 127. Via the guide recess 217, the adjusting wheel 139 protrudes beyond an outer surface 219 of the first locking part 127 and is thus accessible to the user and may be rotated by the user relative to the spindle element 137 arranged inside the first locking part 127.

In addition, the adjusting wheel 139 is fixed in relation to the displacement direction 123 by the guide recess 217 and cannot be moved along the guide direction 123 relative to the first locking part 127.

By rotating the adjusting wheel 139, the toothing between the internal thread 143 of the adjusting wheel 139 and the external thread 145 of the spindle element 137 thus rotates the spindle element 137 out of the adjusting wheel 139 or rotates it into the adjusting wheel 139. This moves the spindle element 137 along the displacement direction 123.

By coupling the spindle element 137 with the screw element 141 via the coupling element 181, the screw element 141 is displaced with the spindle element 137 along the displacement direction 123. In this case, the screw element 141 is arranged to be displaceable relative to the first locking part 127.

By fixing the screw element 141 with the second locking part 129, the second locking part 129 is thus also displaced relative to the first locking part 127 along the displacement direction 123 by rotation of the adjusting wheel 139 and thus by the displacement of the spindle element 137 and the associated displacement of the screw element 141 along the displacement direction 123.

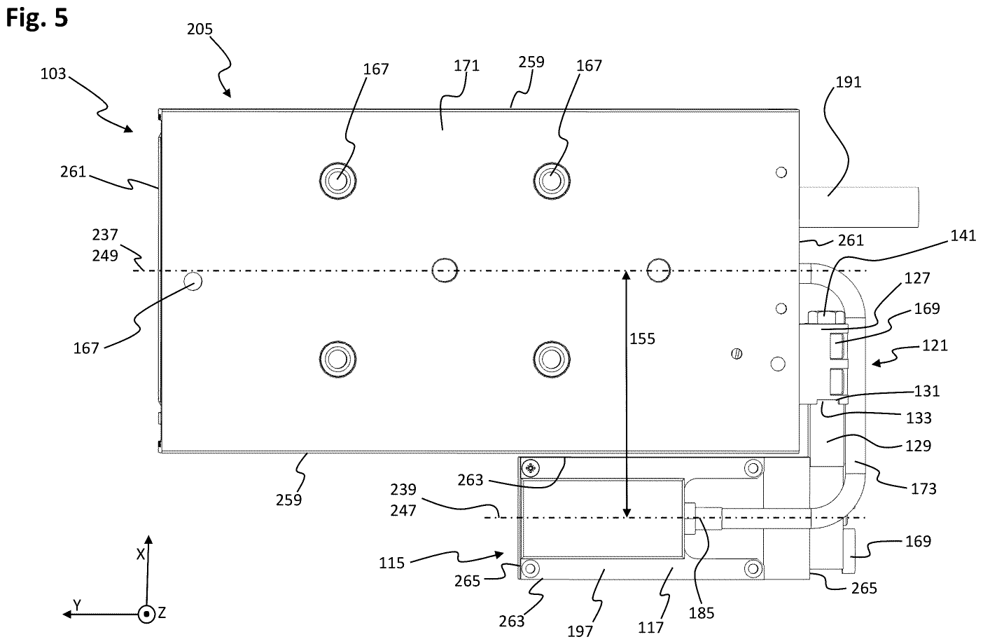

FIG. 5 shows a schematic top view of the rotor assembly 103 with an encoder unit 117 according to an embodiment.

The embodiment shown in FIG. 5 is based on the embodiments shown in FIGS. 1 to 4.

FIG. 5 shows that the first locking part 127 comprises a guide groove 131 running along the displacement direction 123. The second locking part 129 comprises a corresponding guide projection 133, which is positioned in the guide groove 131. When the second locking part 129 is displaced relative to the first locking part 127, the guide projection 133 slides in the guide groove 131 along the displacement direction 123.

According to the embodiments shown, the displacement direction 123 runs in parallel to the z-direction of the coordinate system shown.

In contrast to the embodiment shown, the displacement groove 131 may also be embodied at the second locking part 129, while the displacement projection 133 is embodied at the first locking part 127.

By the parallel embodiment of the displacement groove 131 with regard to the displacement direction 123 and by accommodating the displacement projection 133 by the displacement groove 131, it may be ensured that the second locking part 129 may only be displaced along the predefined displacement direction 123 relative to the first locking part 127.

The encoder unit 117 may thus also only be displaced along the predefined displacement direction 123 relative to the rotor assembly 103 or relative to the drive unit 205 of the rotor assembly 103.

Tilting or twisting of the encoder unit 117, for example about the x-direction or y-direction of the coordinate system shown, is prevented by the guide groove 131 and the guide projection 133 accommodated therein.

The first and second locking parts 127, 129, which are arranged next to each other with respect to the y-direction of the coordinate system shown, are connected to each other by the screw unit 141 extending through the first locking part 127.

The screw unit 141 runs in parallel to the x-axis of the coordinate system shown and thus perpendicular with regard to the predefined displacement direction 123.

Furthermore, FIG. 5 shows that fixing openings 167 are formed on an upper outer surface 232 of the housing unit 171 of the drive unit 205. The drive unit 205 may be fixed to the rotor base 161 via the fixing openings 167.

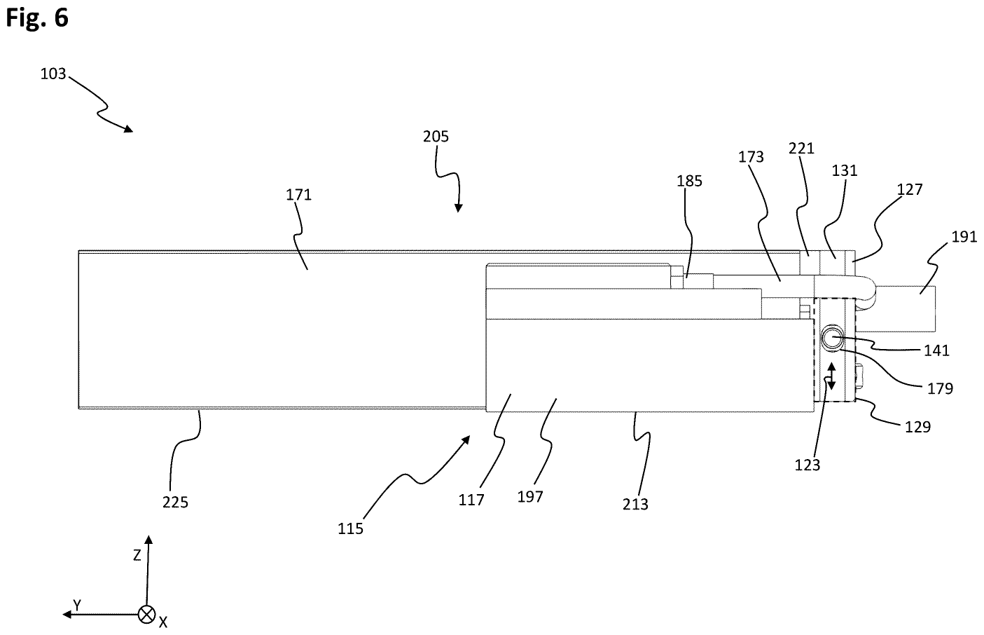

FIG. 6 shows a schematic side view of the rotor assembly 103 with an encoder unit 117 according to an embodiment.

The embodiment shown in FIG. 6 is based on the embodiments in FIGS. 1 to 5.

In FIG. 6, the second locking part 129 is shown in semi-transparent form. Furthermore, the first fixing elements 169 are removed. In FIG. 6, a side surface 221 of the first locking part 127 is shown by the semi-transparent representation of the second locking part 129. The displacement groove 131 is embodied on the side surface 221 along the z-direction of the coordinate system shown. Within the displacement groove 131, a displacement recess 179 is also embodied at the side face 221 of the first locking part 127.

The screw element 141 extends through the displacement recess 179 along the x-axis of the coordinate system shown and protrudes from the side surface 221 of the first locking part 127.

Running through the displacement recess 179, the screw element 141 is screwed to the second locking part 129. The first and second locking parts 127, 129 are fixed to each other by the screw connection with the second locking part 129.

The guide recess 179 extends along the displacement direction 123, so that the screw element 141 is displaceable within the displacement recess 179 in the displacement direction 123.

By rotating the adjusting wheel 139 and the corresponding displacement of the spindle element 137 and the associated displacement of the screw element 141 along the displacement direction 123, as described in detail for FIG. 4, the second locking part 129 may be displaced relative to the first locking part 127 along the displacement direction 123 by fixing the screw element 141 with the second locking part 129.

In the embodiment shown, the displacement recess 179 is elliptical in shape. However, this is merely exemplary and a differently shaped displacement recess 179 is also possible. In addition, the displacement recess 179 may have a greater extension along the displacement direction 123 than is shown in FIG. 6.

FIG. 5 shows that the drive unit 205 has a rectangular shape with two long sides 259 and two short sides 261. The longitudinal centerline 237 of the rotor magnet assembly 111 is oriented in parallel with regard to the longitudinal direction 249 of the drive unit 205. The longitudinal direction 249 is in turn oriented in parallel to the long sides 259 of the drive unit 205.

The encoder unit 117 is also rectangular with two long sides 263 and two short sides 265. The longitudinal centerline 239 of the encoder unit 117 is oriented in parallel with regard to the longitudinal direction 247 of the encoder unit 117, which in turn is oriented in parallel with regard to the long sides 263.

FIG. 6 also shows that the underside 213 of the encoder unit 117 is oriented in parallel to an underside 225 of the drive unit 205.

By displacing the first and second locking parts 127, 129 relative to one another along the displacement direction 123, the sliding of the displacement projection 133 in the displacement groove 131 may prevent the encoder unit 117 from tilting or twisting relative to the rotor assembly 103, so that the underside 213 of the encoder unit 117 remains parallel to the underside 225 of the drive unit 205 when the encoder unit 117 is displaced.

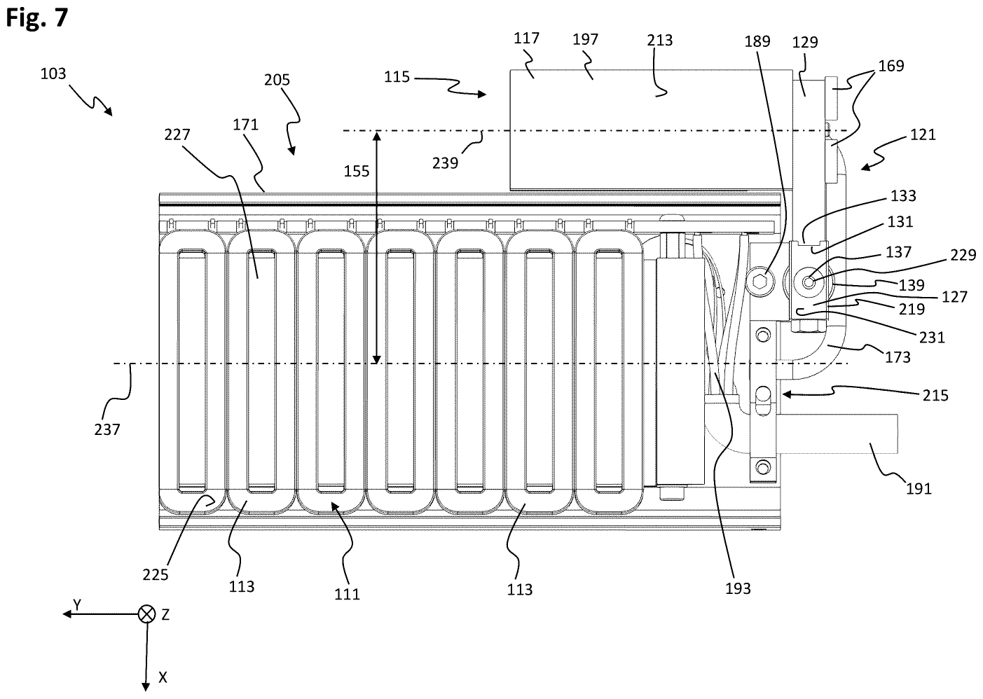

FIG. 7 shows a schematic bottom view of the rotor assembly 103 with the encoder unit 117 according to an embodiment.

The embodiment shown in FIG. 7 is based on the embodiments in FIGS. 1 to 6.

In the embodiment shown, the rotor magnet assembly 111 comprises a plurality of energizable coil units 113. A variable rotor magnetic field may be generated by energizing the coil units 113. The rotor assembly 103 may thus be moved along the guide rails 105, 107 relative to the stator assembly 101 by the magnetic coupling of the rotor magnetic field with the stator magnetic field of the stator magnet assembly 109 of the stator assembly 101 by the corresponding activation or energization of the coil units 113 and the correspondingly variable rotor magnetic field.

The rotor magnet assembly 111 including the coil units 113 is arranged here in an interior 227 of the housing unit 171 of the drive unit 205.

A connection wiring 191 is partially shown at the front end 215 of the drive unit 205. A plurality of cables 193 may be routed into the interior 227 of the housing element 171 via the connection cabling 191. An electrical or data supply to the drive unit 205 and in particular to the coil units 113 is ensured via the cables 193.

Furthermore, it is shown that the first locking part 127 is fixed to the underside 225 of the drive unit 205 via a third fixing element 189.

Furthermore, it may be seen that the adjusting wheel 139 protrudes at least partially through the guide recess 217 from the first locking part 127 and protrudes from the outer surface 219 of the first locking part 127. This allows for the adjusting wheel 139 being easily reached by a user and rotated accordingly to operate the locking device.

FIG. 7 also shows that a displacement opening 229 is embodied on an underside 231 of the first locking part 127. The spindle element 131 may protrude from the first locking part 127 through the displacement opening 229. As a result, a displacement of the first and second locking parts relative to one another may be achieved.

According to an embodiment, the encoder system 115 may be configured as an absolute encoder system 115 or as an incremental encoder system 115.

According to an embodiment, the encoder system 115 may be configured as a magnetic encoder system or an optical encoder system or a capacitive encoder system.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
FIG. references 100-199

| | |
|---|---|
| 100 Drive system | 151 Carrier plate |
| 101 Stator assembly | 153 Receiving groove |
| 103 Rotor assembly | 157 Outer edge |
| 105 First guide rail | 159 Stator base |
| 107 Second guide rail | 161 Rotor base |
| 109 Stator magnet assembly | 163 Positioning holes |
| 111 Rotor magnet assembly | 165 Adjustment openings |
| 113 Coil unit | 167 Fixing openings |
| 115 Encoder system | 169 first fixing element |
| 117 Encoder unit | 171 Housing unit |
| 119 Dimensional scale | 173 Connecting cable |
| 121 Locking device | 175 first guide element |
| 123 Displacement direction | 177 second guide element |
| 125 Distance encoder unit/ | 179 Displacement recess |
| dimensional scale | |
| 127 First locking part | 181 Coupling element |
| 129 Second locking part | 183 Cable guide |
| 131 Displacement groove | 185 Connecting plug element |
| 133 Displacement projection | 187 second fixing element |
| 135 Actuating unit | 189 third fixing element |
| 137 Spindle element | 191 Connecting cabling |
| 139 Adjusting wheel | 193 Cables |
| 141 Screw element | 195 Feed-through opening |
| 143 Internal thread | 197 Encoder housing |
| 145 External thread | 199 Front cover |
| 147 Carrier unit | |
| 149 Distance longitudinal centerline to | |
| stator magnet assembly/dimensional scale | |
| 155 Distance longitudinal centerline to | |
| rotor magnet assembly/encoder system | |

TABLE 2
FIG. references 200-273

| | |
|---|---|
| 201 Fixing base | 239 Longitudinal centerline of encoder unit |
| 203 Carrier element | 241 Top of dimensional scale |
| 205 Drive unit | 243 Threaded pin |
| 207 Longitudinal direction | 245 Fastening element |
| 209 Top side | 247 Longitudinal direction of encoder unit |
| 211 Underside | 249 Longitudinal direction of drive unit |
| 213 Underside of encoder unit | 251 Bottom side of rotor magnet assembly |
| 215 Front end | 253 Top side of stator magnet assembly |
| 217 Guide recess | 255 Longitudinal direction of dimensional |
| | scale |
| 219 Outer surface | 257 Longitudinal direction of stator magnet |
| | assembly |
| 221 Side surface | 259 Long side of drive unit |
| 223 Further positioning holes | 261 Short side of drive unit |
| 225 Underside of drive unit | 263 Long side of encoder unit |
| 227 Interior of housing unit | 265 Short side of encoder unit |
| 229 Displacement opening | 267 Long side of stator magnet assembly |
| 231 Bottom side of first locking part | 269 Short side of stator magnet assembly |
| 233 Longitudinal centerline stator | 271 Long side of dimensional scale |
| magnet assembly | |
| 235 Longitudinal centerline dimensional | 273 Short side of dimensional scale |
| scale | |
| 237 Longitudinal centerline rotor magnet | A Section |
| assembly | |

1. A linear drive system, comprising:
a stator assembly, and
a rotor assembly,
wherein the stator assembly comprises at least one guide rail on which the rotor assembly is configured to travel,
wherein the stator assembly comprises a stator magnet assembly configured for providing a stator magnetic field,
wherein the rotor assembly comprises a rotor magnet assembly configured for providing a rotor magnetic field, and
wherein the rotor assembly is moveable along the guide rail via a magnetic coupling between the stator magnetic field and the rotor magnetic field; and
further comprising an encoder system having an encoder unit arranged on the rotor assembly and a dimensional scale arranged on the stator assembly,
wherein the encoder unit is fixed to the rotor assembly via a locking device, and the encoder unit being displaceable relative to the rotor assembly along at least one predefined displacement direction via the locking device, and
a distance between the encoder unit and the dimensional scale being variable via the displacement of the encoder unit along the at least one displacement direction when the rotor assembly is positioned on the guide rail.

2. The drive system according to claim 1, wherein:
the encoder unit is displaceable relative to the rotor assembly along the predefined displacement direction via the locking device; and
the displacement direction is oriented perpendicular with regard to an underside of the encoder unit and/or perpendicular with regard to an underside of a drive unit of the rotor assembly.

3. The drive system according to claim 1, wherein the locking device is configured to achieve a stepless displacement of the encoder unit relative to the rotor assembly along the direction of displacement.

4. The drive system according to claim 1, wherein:
the locking device comprises a first locking part fixed to the rotor assembly and a second locking part fixed to the transmitter unit;
wherein the first locking part or the second locking part comprises a displacement groove oriented in parallel to the displacement direction,
wherein the respective other locking part comprises a displacement projection receivable by the displacement groove, and
wherein the first and second locking parts are displaceable relative to each other along the displacement direction by sliding of the displacement projection along the displacement groove.

5. The drive system according to claim 4, wherein:
the locking device comprises an actuating unit configured for achieving the displacement of the first and second locking parts;
wherein the actuating unit comprises a spindle element connected to the first and/or second locking part, and
wherein the first and second locking parts are displaceable relative to one another via the spindle element.

6. The drive system according to claim 5, wherein:
the actuating unit comprises an adjusting wheel connected to the spindle element as an operating element for a user; and
wherein the adjusting wheel is rotatable relative to the spindle element.

7. The drive system according to claim 3, wherein:
the first and second locking parts are connected to each other via a screw element;
wherein the spindle element is connected to the screw element at right angles,
wherein the adjusting wheel is intermeshed with an external thread of the spindle element via an internal thread, and
wherein the screw element is arranged in the first or second locking part so as to be displaceable along the direction of displacement.

8. The drive system according to claim 4, wherein the spindle element is oriented in parallel with regard to the displacement direction.

9. The drive system according to claim 4, wherein the first and second locking parts are arranged at a distance from each other with respect to a direction perpendicular with regard to the displacement direction.

10. The drive system according to claim 1, wherein:
the dimensional scale is arranged on a carrier unit;
wherein the carrier unit is detachably arranged along the stator magnet assembly on the stator assembly, and
wherein a longitudinal centerline of the dimensional scale is arrangeable on the stator assembly at a distance from a longitudinal centerline of the stator magnet assembly.

11. The drive system according to claim 1, wherein the encoder unit is fixed to the rotor assembly with the aid of the locking device such that a longitudinal centerline of a detection unit of the encoder unit facing the dimensional scale is at a distance from a longitudinal centerline of the rotor magnet assembly.

12. The drive system according to claim 11, wherein:
the longitudinal centerline of the stator magnet assembly and the longitudinal centerline of the rotor magnet assembly are configured in a congruent manner along an x-axis and are aligned in parallel with regard to each other along a y-axis, and
the dimensional scale and the encoder unit are arranged on a joint side laterally of the longitudinal centerline of the stator magnet assembly and of the longitudinal centerline of the rotor magnet assembly with regard to the x-axis; and
wherein the distance between the longitudinal centerline of the dimensional scale and the longitudinal centerline of the stator magnet assembly and the distance between the longitudinal centerline of the encoder unit and the longitudinal centerline of the rotor magnet assembly have an identical length.

13. The drive system according to claim 1, wherein the encoder system is configured as a magnetic encoder system or an optical encoder system or a capacitive encoder system.

14. The drive system according to claim 1, wherein the encoder system is configured as an incremental encoder system and/or an absolute encoder system.

15. The drive system according to claim 1, wherein the stator assembly comprises two guide rails running in parallel with regard to each other, and wherein the dimensional scale is arranged between the two guide rails on the stator assembly.

16. A rotor assembly comprising an encoder unit of an encoder system in combination with the linear drive system according to claim 1.

17. A stator assembly comprising a dimensional scale of an encoder system in combination with the linear drive system according to claim 1.
